(19) United States
(12) Patent Application Publication
(10) Pub. No.: US 2022/0379883 A1
(43) Pub. Date: Dec. 1, 2022

(54) METHOD FOR CONTROLLING A MOTOR VEHICLE

(71) Applicant: Nissan Motor Co., Ltd., Yokohama-shi, Kanagawa (JP)

(72) Inventors: Geoffrey BRUNO, Issy les Moulineaux (FR); Sébastien CHEDEVILLE, Pacy Sur Eure (FR); Anh-Lam DO, Antony (FR); Nicolas LETELLIER, Pont de l'Arche (FR); Khoa Duc NGUYEN, Sartrouville (FR)

(21) Appl. No.: 17/775,903

(22) PCT Filed: Nov. 12, 2020
(86) PCT No.: PCT/EP2020/081825

§ 371 Date: May 11, 2022

(30) Foreign Application Priority Data
Dec. 6, 2019 (FR) FR1913862

(51) Int. Cl. B60W 30/09; B60W 60/00; B60W 30/095

(52) U.S. Cl. CPC B60W 30/09; B60W 60/0015; B60W 30/0953; B60W 30/0956; B60W 2554/4041; B60W 2540/00; B60W 2520/00; B60W 2552/30; B60W 10/184

(57) ABSTRACT

A method automatically controls an actuator of a control system of an automotive device. The method includes determining a reference trajectory, determining a position of the device with respect to the reference trajectory, acquiring a parameter relating to a force exerted by a driver on a manual control device of the control system, and calculating a controlling setpoint of the actuator. The controlling setpoint is calculated as a function of the parameter and of the position of the device with respect to the reference trajectory.

### CROSS-REFERENCE T0 RELATED APPLICATIONS

This application is a U.S. national stage application of International Application No. PCT/EP2020/081825, filed on Nov. 12, 2020, which claims priority to French Application No. 1,913,862, filed on Dec. 6, 2019.

### BACKGROUND

### Technical Field

The present invention relates generally to the automation of automotive device trajectory tracking.

It is particularly advantageous in the context of motor vehicle driving assistance, but it can also be applied to the field of aeronautics or robotics.

It relates also to a device equipped with a computer adapted to implement this method.

### Background Information

For safety, motor vehicles are increasingly often equipped with driving assist systems or autonomous driving systems.

Among these systems, notably known are the automatic emergency braking (AEB) systems, designed to avoid any collision with obstacles situated in the lane being taken by the vehicle, by acting simply on the conventional braking system of the motor vehicle.

There are however situations in which these emergency braking systems do not make it possible to avoid the collision or are simply not usable (for example if a vehicle is following close to the motor vehicle).

For these situations, automatic avoidance systems (better known by the abbreviation AES, which stands for “Automatic Evasive Steering” or “Automatic Emergency Steering”) which make it possible to avoid the obstacle by diverting the vehicle from its trajectory, either by acting on the steering of the vehicle, or by acting on the differential braking system of the vehicle, have been developed.

It may be that this AES system, to avoid an obstacle, comes into conflict with the driver so as to force the vehicle to follow an avoidance trajectory different from that that the driver wanted to take. The result of this is at best a hindrance for the driver (who then risks deactivating the AES system to the detriment of his or her safety), and at worst lack of understanding for the driver potentially causing the latter to have a poor understanding of the situation.

The management of the interaction between the driver and this AES system therefore proves in practice to be difficult.

### SUMMARY

The present invention therefore proposes enhancing the existing AES systems, by adding to them an additional function guaranteeing a better arbitration between the wishes of the driver and the decisions taken by the AES system.

More particularly, according to the invention, a method is proposed as defined in the introduction, wherein the controlling setpoint is calculated as a function of the parameter and as a function of the position of the device with respect to the reference trajectory.

Thus, by virtue of the invention, the trajectory taken by the automotive device depends not only on the setpoint generated by the AES system, but also on the will expressed by the driver.

The invention then makes it possible to arbitrate and favor the AES system or the will expressed by the driver, as a function of the circumstances encountered, and in particular as a function of the position of the automotive device with respect to the obstacle.

The invention thus makes it possible to avoid having the driver being able to be in situations of lack of understanding, while guaranteeing him or her the best possible driving comfort.

Other advantageous and nonlimiting features of the control method according to the invention, taken individually or according to all technically possible combinations, are as follows:
the device is a motor vehicle which is suitable for traveling on roads and which comprises at least one drive wheel,
the manual control means is a steering wheel,
the control system allows each drive wheel to be steered,
the parameter relates to the torque exerted by the driver of the motor vehicle on the steering wheel;
the reference trajectory is determined such that the device avoids an obstacle,
taking into consideration at least two zones of the environment of the device whose limits depend on the position of the obstacle and/or on the position of the reference trajectory with respect to the obstacle, the calculation of the controlling setpoint is performed by determining the zone in which the device is located, then by using an algorithm for calculating the controlling setpoint which is selected as a function of the zone in which the device is located;
provision is made to determine an indicator whose value depends on the zone in which the device is located and on the parameter, provision is made to generate a preliminary controlling setpoint of the actuator that makes it possible to bring the device to the reference trajectory, and provision is made to correct the preliminary setpoint as a function of the value of the indicator;
the indicator being adapted to take only one or other of two values, provision is made to determine, as a function of the indicator, a corrected indicator which varies continually between two values, and the preliminary setpoint is corrected by multiplying its value by that of the corrected indicator;
when the corrected indicator varies, the rate of variation of the corrected indicator is determined as a function of a speed of the motor vehicle and of the radius of curvature of the road, such that the lateral acceleration of the motor vehicle does not exceed a determined threshold;
the preliminary setpoint is deduced from a steering angle setpoint of the wheels which is itself calculated as a function of the position of the device with respect to the reference trajectory and which is filtered by means of a controller which satisfies a setpoint amplitude limiting model and a setpoint variation limiting model;
the computer considers four zones associated with four different computation algorithms, namely:
a zone situated upstream of the obstacle, between the reference trajectory and a protection line beyond which any collision with the obstacle is avoided,
a zone situated level with and downstream of the obstacle, between the reference trajectory and the protection line,
a zone situated upstream of the obstacle, on the side of the reference trajectory which is opposite the protection line, and
a zone of which a part is situated upstream of the obstacle, on the side of the protection line which is opposite the reference trajectory, and of which another part is situated level with and downstream of the obstacle, on the side of the reference trajectory which is opposite the protection line;
when the device moves from a first zone to a second zone, the computer continues to use the algorithm associated with the first zone as long as the device has not gone beyond a hysteresis trajectory determined as a function of the reference trajectory;
the reference trajectory is determined so as to avoid an obstacle by circumventing at least one protection limit situated around a part of the obstacle;
a first protection limit has a form and a position which are a function of the form of the obstacle and/or of the measurement errors of the sensors with which the motor vehicle is equipped and/or of the speed of the obstacle;
a second protection limit has a form and a position which are a function of a predetermined safety margin.

The invention also proposes an automotive device such as a car, comprising at least one actuator which is adapted to influence the trajectory of the device and a computer for controlling the actuator, which is programmed to implement a method as specified above.

Of course, the various features of the invention can be associated with one another according to various combinations insofar as they are not mutually incompatible or exclusive.

### BRIEF DESCRIPTION OF THE DRAWINGS

The description given below in light of the attached drawings, given as nonlimiting examples, will give a good understanding of what the invention consists of and how it can be produced.

In the attached drawings:

FIG. 1 is a top schematic view of a motor vehicle traveling on a road, on which the avoidance trajectory that this vehicle must take is represented;

FIG. 2 is a block diagram illustrating the architecture of a control system suitable for implementing a control method according to the invention;

FIG. 3 is a schematic view of an obstacle, of the motor vehicle of FIG. 1, of its obstacle avoidance trajectory and of different zones used in the context of the control method according to the invention;

FIG. 4 is a schematic view of an obstacle, of the obstacle avoidance trajectory and of two trajectories that can be envisaged in the context of a first example of use of the control method according to the invention;

FIG. 5 is a graph, plotted on the basis of that of FIG. 4, representing the trend of different controlling torques of the motor vehicle;

FIG. 6 is a schematic view of an obstacle, of the obstacle avoidance trajectory and of two trajectories that can be envisaged in the context of a first example of use of the control method according to the invention;

FIG. 7 is a graph, plotted on the basis of that of FIG. 6, representing the trend of different controlling torques of the motor vehicle;

FIG. 8 is a schematic view of an obstacle, of the obstacle avoidance trajectory and of two trajectories that can be envisaged in the context of a first example of use of the control method according to the invention;

FIG. 9 is a graph, plotted on the basis of that of FIG. 8, representing the trend of different controlling torques of the motor vehicle;

FIG. 10 is a schematic view of an obstacle, of the obstacle avoidance trajectory and of two trajectories that can be envisaged in the context of a first example of use of the control method according to the invention;

FIG. 11 is a graph, plotted on the basis of that of FIG. 10, representing the trend of different controlling torques of the motor vehicle;

FIG. 12 is a schematic view of an obstacle, of the obstacle avoidance trajectory and of two trajectories that can be envisaged in the context of a first example of use of the control method according to the invention;

FIG. 13 is a graph, plotted on the basis of that of FIG. 12, representing the trend of different controlling torques of the motor vehicle;

FIG. 14 is a schematic view of an obstacle, of the obstacle avoidance trajectory and of two trajectories that can be envisaged in the context of a first example of use of the control method according to the invention;

FIG. 15 is a graph, plotted on the basis of that of FIG. 14, representing the trend of different controlling torques of the motor vehicle;

FIG. 16 is a graph illustrating an example of variation of steering angle setpoint as a function of time;

FIG. 17 is a graph plotted on the basis of that of FIG. 16, illustrating the instants of activation and of deactivation of the control systems of the vehicle of FIG. 1 in the context of the control method according to the invention; and

FIG. 18 is a graph plotted on the basis of that of FIG. 16, illustrating the variations of the parameters K1 and K1ᵣₜ used in the context of the method according to the invention.

### DETAILED DESCRIPTION OF EMBODIMENTS

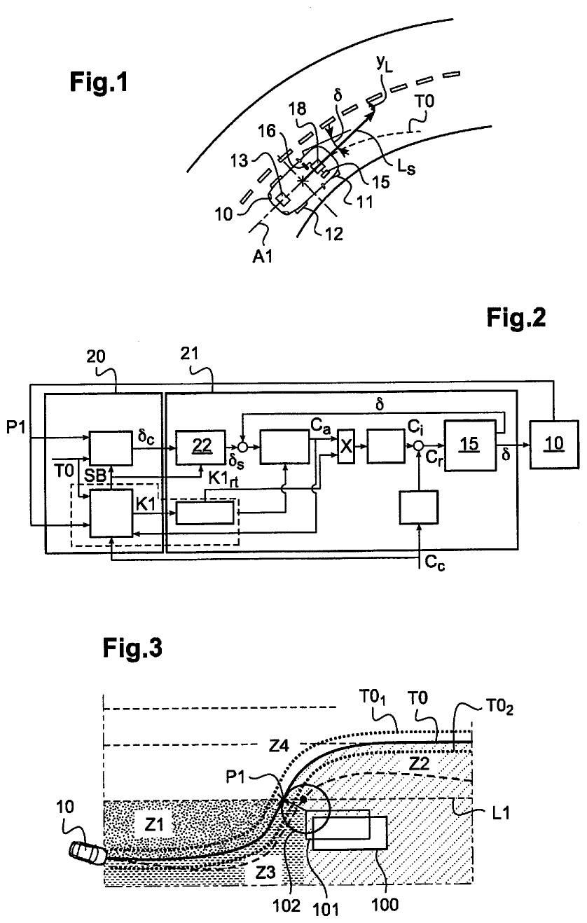

FIG. 1 shows a motor vehicle 10 traveling on a road. In the following example, the case will be considered in which the law demands that the vehicle be driven on the right lane, but the invention will be able to be applied likewise, symmetrically, to the case of driving on the left (as is the case for example in the United Kingdom).

As FIG. 1 shows, the motor vehicle 10 conventionally comprises a chassis which delimits a vehicle interior, two front drive wheels 11, and two rear non-drive wheels 12. As a variant, these two rear wheels could also be drive wheels.

This motor vehicle 10 comprises a conventional steering system 18 that makes it possible to act on the orientation of the front wheels 11 so as to be able to turn the vehicle. In the example considered, the steering system 18 is controlled by an assisted steering actuator 15 which makes it possible to act on the orientation of the front wheels 11 as a function of the orientation of the steering wheel 16 and/or, as the case may be, as a function of a setpoint issued by a computer 13.

In addition, it would be possible to provide for this motor vehicle to include a differential braking system making it possible to act differently on the speeds of rotation of the front wheels 11 (even also on those of the rear wheels 12) so as to slow down the motor vehicle by making it turn. This differential braking system would for example comprise a controlled differential or electric motors placed at the wheels of the vehicle.

Hereinafter in this explanation, the steering system considered will be formed by just the conventional steering system. As a variant, it could be formed by the combination of the conventional steering system and of the differential braking system.

The computer 13 is provided to control the actuator 15. To this end, it comprises at least one processor, at least one memory and different input and output interfaces.

By virtue of its input interfaces, the computer 13 is adapted to receive input signals originating from various sensors.

Among these sensors, the following are for example provided:
a device such as a front-mounted camera, making it possible to mark the position of the vehicle with respect to its traffic lane,
a device such as a RADAR or LIDAR remote sensor, making it possible to detect an obstacle 100 located on the trajectory of the motor vehicle 10 (FIG. 3),
at least one side-mounted device such as a RADAR or LIDAR remote sensor, making it possible to observe the environment on the sides of the vehicle,
a device such as a gyrometer, making it possible to determine the speed of yaw rotation (about a vertical axis) of the motor vehicle 10, and
a sensor of force exerted on the steering wheel and/or a steering wheel angular position sensor.

By virtue of its output interfaces, the computer 13 is adapted to transmit a setpoint to the assisted steering actuator 15.

It thus makes it possible to ensure that the vehicle follows best, and if conditions justify it, a reference trajectory, formed in the example illustrated in FIG. 3 by an obstacle 100 avoidance trajectory T0.

By virtue of its memory, the computer 13 stores data used in the context of the method described hereinbelow.

It stores in particular a computer application, composed of computer programs, comprising instructions, the execution of which by the processor allows the computer to implement the method described hereinbelow.

It stores notably two computer applications, a first application hereinafter called “AES system 20”, that makes it possible to determine the avoidance trajectory T0 to be followed as well as a steering angle setpoint δ_{c} allowing the motor vehicle 10 to follow that avoidance trajectory T0, and a second application hereinafter called “EPS system 21”, that makes it possible to determine the setpoint to be sent to the assisted steering actuator 15, taking into account the abovementioned steering angle setpoint δ_{c} and the will expressed by the driver.

The will expressed by the driver is, here, deduced from the torque exerted by the driver on the steering wheel 16, which will hereinafter be called “steering wheel torque Cc”. As a variant, it could be deduced as a combination of this steering wheel torque and other factors such as, for example, the angular position of the steering wheel.

Before describing these two systems AES and EPS in detail, the different variables which will be used in the context of the control method described hereinbelow, and some of which are illustrated in FIG. 1, can be introduced.

The steering angle that the front drive wheels make with the longitudinal axis A1 of the motor vehicle 10 will be denoted “δ” and will be expressed in radians.

The lateral deviation between the longitudinal axis A1 of the motor vehicle 10 (passing through the center of gravity CG) and the avoidance trajectory T0, at a sighting distance “ls” situated in front of the vehicle, will be denoted “y_{L}” and will be expressed in meters.

The abovementioned sighting distance “ls” will be measured from the center of gravity CG and will be expressed in meters.

The speed of the motor vehicle on the longitudinal axis A1 will be denoted “V” and will be expressed in m/s.

FIG. 2 shows the abovementioned two systems AES 20 and EPS 21. The way in which these systems operate in practice can then be explained.

When the motor vehicle 10 travels on a road along an initial trajectory (not represented and substantially parallel to the road) and a potentially dangerous obstacle 100 is detected, the AES system is activated.

A potentially dangerous obstacle is a fixed obstacle situated on the initial trajectory or in proximity thereto, or a moving obstacle whose trajectory risks intersecting the initial trajectory.

This system AES 20 then receives as inputs parameters P1 that make it possible to characterize the attitude of the motor vehicle 10 in its environment. These are, for example, its lateral deviation y_{L} at the sighting distance ls, its heading with respect to the road, its yaw speed, etc.

It is also adapted to determine, or to receive from another computer, an obstacle 100 avoidance trajectory T0. This avoidance trajectory T0 is for example generated as a function of the abovementioned parameters P1 and of the characteristics of the obstacle 100 (dimensions, speed, etc.).

In FIG. 3 and in all of the examples which will be considered hereinbelow, it can be seen that this avoidance trajectory T0 is planned to avoid the obstacle 100 on the left, by circumventing the protection limits 101 and 102 making it possible to avoid any collision with the obstacle.

The first protection limit 101, of rectangular form, has a form which is a function of the form of the obstacle 100 and of any measurement errors of the sensors with which the motor vehicle is equipped. It has a position which takes account of the possible speed of the obstacle 100.

The second protection limit 102 has dimensions chosen as a function of the safety margin that is wanted to be given. Here, it takes the form of a circle whose center is situated on the corner of the first protection limit 101 which is located closest to the avoidance trajectory T0.

The way in which the avoidance trajectory T0 is generated is not here specifically the object of the present invention and will not therefore be described in detail.

Given the parameters P1 and the avoidance trajectory T0, the AES system 20 is able to determine a preliminary steering angle setpoint δ_{c} of the front wheels 11 of the vehicle, which would allow the vehicle to best follow this avoidance trajectory T0.

The EPS system 21, which receives as input this preliminary steering angle setpoint δ_{c}, uses a controller 22 to determine a filtered steering angle setpoint δₛ, which is saturated in amplitude and in rate of variation.

In other words, the preliminary steering angle setpoint δ_{c} is capped if it exceeds (in absolute value) a predetermined threshold, and it is regulated so as not to be able to vary faster than another predetermined limit.

These thresholds are chosen such that the motor vehicle 10 remains controllable by the driver at any moment, in the eventuality of possibly taking over sole control of the vehicle.

The deviation between this filtered steering angle setpoint δ_{c} and the instantaneous steering angle δ of the drive wheels 11 (measured by an angle sensor) is then used to determine a preliminary torque setpoint Ca which, if it were directly sent to the assisted steering actuator 15, would make it possible to control the steering of the wheels in accordance with the filtered steering angle setpoint δₛ.

This preliminary torque setpoint Ca is then multiplied by a parameter K1ᵣₜ, the calculation of which will be explained hereinbelow, which makes it possible to obtain an intermediate torque setpoint Ci.

The deviation between this intermediate torque setpoint Ci and the steering wheel torque Cc (to within a multiplying term) makes it possible to obtain a final torque setpoint Cr which is sent to the assisted steering actuator 15.

The invention relates here more specifically to the calculation of the abovementioned parameter K1ᵣₜ.

This parameter, hereinafter called “corrected gain K1ᵣₜ”, is used to deactivate the AES system 20 when the conditions allow it and the driver seems to want to take back control of the driving of the motor vehicle 10.

To check whether the conditions allow it, provision here is made to determine the zone of the environment of the obstacle 100 in which the motor vehicle 10 is located.

Before detailing how this corrected gain K1ᵣₜ is calculated, the zones of the environment which will be considered to implement these calculations can be detailed.

As FIG. 3 shows, four zones of the environment are preferentially distinguished. It would, as a variant, be possible to consider a lower number (at least two) or a higher number, and it would be possible to delimit these zones differently.

Here, these four zones are defined with respect to the avoidance trajectory T0, with respect to the obstacle 100 and with respect to a protection line L1 beyond which any collision with the obstacle 100 is avoided.

This protection line L1 corresponds more specifically to a virtual line which is parallel to the road (here it is rectilinear, but it could be curved if the road were curved) and which passes through the point P₁ of the second protection limit 102 which is furthest away from the obstacle 100.

The crossing of this line by the motor vehicle 10 (and more specifically by its center of gravity CG) makes it possible to ensure that the obstacle 100 is well avoided.

The four zones are defined as follows.

The first zone Z1 is situated upstream of the obstacle (more specifically here, upstream of the first protection limit 101), between the avoidance trajectory T0 and the protection line L1.

In this first zone Z1, the will of the driver is supposed to be close to the setpoint calculated by the AES system 20, so that, for safety, there is no wish for the operation of the AES system to be able to be suspended.

The second zone Z2 is situated level with and downstream of the obstacle (more specifically here level with and downstream of the first protection limit 101), between the avoidance trajectory T0 and the protection line L1.

Because this zone is situated behind the obstacle 100 and there is therefore no longer any danger, it is desirable here to allow the driver the possibility of entirely taking back control of the vehicle, as long as he or she has both hands on the steering wheel.

The third zone Z3 is situated upstream of the obstacle 100 (more specifically here upstream of the first protection limit 101), on the other side of the reference trajectory T0 with respect to the first zone Z1.

In this zone, the wish is to be able to allow the driver the possibility of taking back control of the driving of the vehicle provided that he or she firmly counters the AES system 20.

The fourth zone Z4 covers the rest of the environment.

In this fourth zone, the wish is to be able to allow the driver the possibility of taking back control of the driving of the vehicle if he or she counters the AES system 20. Thus, in the fourth zone, as soon as the driver opposes the maneuver ordered by the AES system, however softly, the AES request is interrupted.

To calculate the corrected gain K1ᵣₜ, the computer 13 determines in which of these four zones the motor vehicle 1 is located, then it uses a computation algorithm which is not the same from one zone to another.

When the motor vehicle 10 changes zone, the computer does not immediately change computation algorithm, so as not to generate instability. It then changes algorithm only when the vehicle goes beyond a so-called hysteresis trajectory, calculated as a function of the avoidance trajectory T0.

In FIG. 3, two hysteresis trajectories T0₁, T0₂ are represented which follow the avoidance trajectory T0 at a predetermined constant distance, for example one meter, to the right or to the left thereof.

When the motor vehicle 10 passes from the zone Z1 to the zone Z3 (or vice versa), or from the zone Z2 to the zone Z4 (or vice versa), the computer changes computation algorithm only after the vehicle has crossed not only the avoidance trajectory T0, but also these two hysteresis trajectories T0₁, T0₂, which notably makes it possible to avoid the phenomenon of oscillation between the zones.

The way in which the corrected gain K1ᵣₜ is calculated can now be described in detail.

The value of this corrected gain K1ᵣₜ is deduced from the value of a gain K1 which is a boolean whose value is determined as follows.

If the motor vehicle is located in the first zone Z1, this gain K1 is set equal to one, which means that there is no wish to interrupt the AES system 20.

If the motor vehicle is located in the second zone Z2, the driver has both hands on the steering wheel and the steering wheel torque Cc is, in absolute value, above a first threshold Cc2, the gain K1 is set equal to zero, which means that there is a wish to interrupt the AES system 20.

In any other situation in the third zone Z2, the gain K1 is set equal to one.

If the motor vehicle is located in the third zone Z3 and the driver intends to avoid the obstacle on the right (contrary to the AES system 20), while remaining in zone Z3, that is to say by shifting minimally with respect to the obstacle 100, the gain K1 is set equal to zero, which means that there is a wish to interrupt the AES system 20.

For the computer 13 to consider that the driver intends to avoid the obstacle on the right by shifting minimally, it checks whether the steering wheel torque Cc is negative and whether it is below a negative threshold Cc₃ₘᵢₙ (for example −2 Nm).

Mirroring this, if the motor vehicle is located in the third zone Z3, the driver intends to avoid the obstacle on the left (contrary to the AES system 20) by exerting a steering wheel torque CC above a threshold Cc₃ₘₐₓ (for example 2 Nm), and the AES system generates a negative torque, the gain K1 is also set equal to zero, which means that there is a wish to interrupt the AES system 20.

In any other situation in the third zone Z3, the gain K1 is set equal to one, which means that there is a wish to maintain the AES system 20.

If the motor vehicle is located in the fourth zone Z4 and the driver wants to revert to his or her initial lane or at least cancel the lateral speed of the motor vehicle 10 by imposing a steering wheel torque Cc that is negative and below a threshold Cc₄ₘᵢₙ in which is itself negative (for example −3 Nm), and the AES system generates a positive torque, the gain K1 is set equal to zero.

If the motor vehicle is located in the fourth zone Z4 and the driver wants to change lane by continuing to move away to the maximum from the obstacle 100 by imposing a positive steering wheel torque Cc above a threshold Cc₄ₘₐₓ that is itself positive (for example 3 Nm), and the AES system generates a negative torque, the gain K1 is set equal to zero.

In any other situation in the fourth zone Z4, the gain K1 is set equal to one.

It will be noted that, in the case where the gain K1 is equal to zero and at least one of the abovementioned conditions is no longer fulfilled, it is immediately set once again to one.

The computer 13 is then able to calculate the corrected gain K1ᵣₜ which, here, is a real number lying between zero and one and which varies continually.

This corrected gain K1ᵣₜ is determined so as to avoid any abrupt modification in the control of the motor vehicle 10.

Provision is made to vary with a constant gradient. In other words, the rate of variation of this corrected gain K1ᵣₜ is either zero (when its value is equal to zero or one), or constant and equal to a predetermined speed. Thus, as FIG. 18 shows, if the gain K1 exhibits a variation in the form of rectangular pulses, the corrected gain K1ᵣₜ exhibits a variation in the form of trapezoidal pulses whose rising and falling edges are not vertical but oblique, in the form of ramps.

Provision will be able to be made for the rate of variation on the rising edge to be greater than that exhibited on the falling edge. Each rising edge will begin when the gain K1 changes from zero to one, and each falling edge will be triggered when the gain K1 changes from one to zero.

The rate of variation upon each rising or falling edge is determined as a function of the speed V of the vehicle and of the radius of curvature of the road, such that the lateral acceleration of the vehicle does not exceed a threshold (for example of 1 m·s⁻²).

The gradient used will therefore be commensurately lower when the speed V is high, and commensurately greater when the radius of curvature of the road is great. A mapping that makes it possible to determine the gradient to be used will be able to be used.

Once the corrected gain K1ᵣₜ is obtained, the latter is multiplied with the preliminary torque setpoint Ca.

When this corrected gain K1ᵣₜ is equal to one, which means that the AES system 20 is operational, this preliminary torque setpoint Ca is not modified, and the assisted steering actuator 15 is controlled by only the AES system 20.

When the corrected gain K1ᵣₜ is equal to zero, which means that the operation of the AES system 20 must be suspended, this preliminary torque setpoint Ca is canceled, and the assisted steering actuator 15 is controlled by only the steering wheel 16.

The variations of the corrected gain K1ᵣₜ between zero and one make it possible to transition gradually and gently from one mode of operation to the other, avoiding the threshold effects.

In FIG. 2, two signals SA, SB are represented that correspond to reset signals.

These two reset signals SA, SB make it possible, notably, to reset to zero the calculation of the preliminary torque setpoint Ca and assign the measured steering angle value δ to the filtered steering angle setpoint δₛ when the corrected gain K1ᵣₜ changes from zero to a non-zero value.

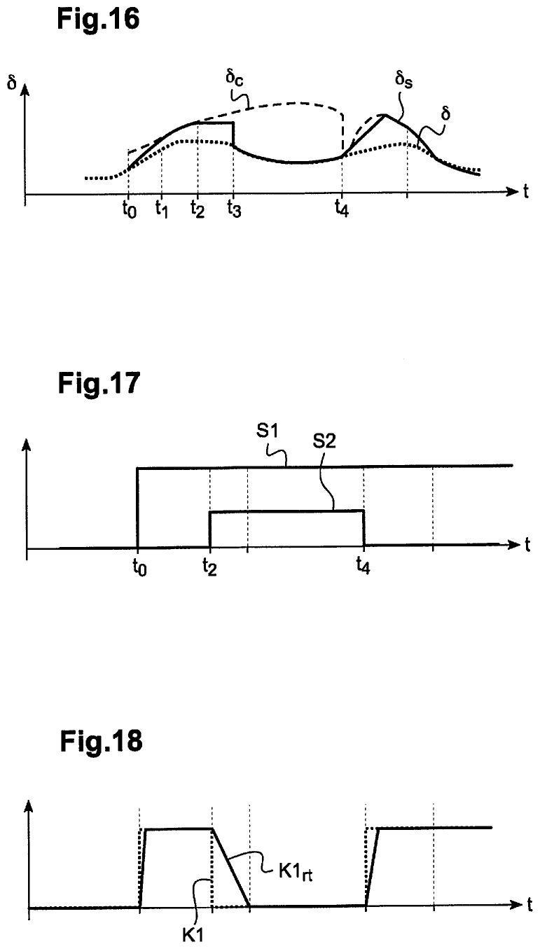

The benefit of these two signals will become clearly apparent hereinafter in the present explanation, with reference to FIGS. 16 to 18.

Several particular cases illustrating the benefit of the invention can now be described.

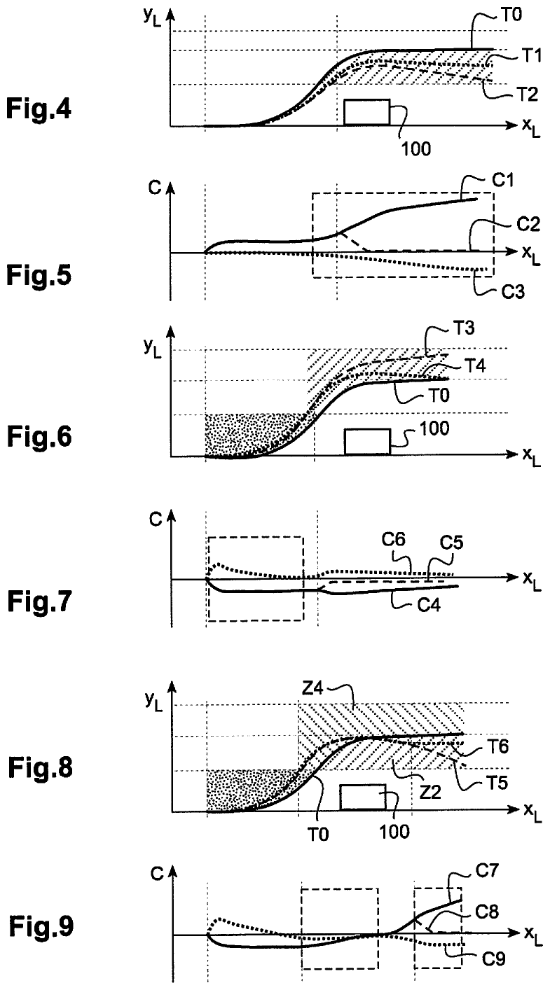

The first particular case, illustrated in FIGS. 4 and 5, corresponds to a situation in which, after the first obstacle 100 avoidance phase, the motor vehicle 10 enters into the second zone Z2, and the driver wants to very rapidly return to his or her initial traffic lane.

In this situation, the driver turns the steering wheel to the right by exerting a steering wheel torque Cc which is negative. This steering wheel torque is illustrated in FIG. 4 by the curve C3.

In this situation, the AES system 20 calculates a positive torque (that is to say taking the vehicle to the left) that makes it possible to bring the motor vehicle 10 to the avoidance trajectory T0. This torque is illustrated in FIG. 5 by the curve C1. The curve T1 illustrated in FIG. 4 shows the trajectory which would be followed by the motor vehicle 10 if it were controlled without interrupting the operation of the AES system 20.

It is then understood that, without the invention, that is to say without this possibility of interrupting the AES system 20, the steering wheel torque and the torque generated by the AES system will be opposite, which will create a bad feeling for the driver.

Now, since the situation envisaged here is not dangerous, it does not impose countering the will of the driver.

Then, by virtue of the invention, the gain K1 is chosen equal to zero, so that the corrected gain K1ᵣₜ will transition continually from one to zero. The intermediate torque setpoint Ci will then decrease gradually until it is canceled (see the curve C2 in FIG. 5), which will allow the vehicle to return to the initial lane (see the trajectory T2 illustrated in FIG. 4), as the driver wishes.

The second particular case, illustrated in FIGS. 6 and 7, corresponds to a situation in which the driver would want to perform an avoidance greater than that planned by the AES system 20, in order, for example, to change traffic lane.

In this situation, after having gone beyond the obstacle 100, the driver continues to turn the steering wheel to the left by exerting a steering wheel torque Cc which is positive. This steering wheel torque is illustrated in FIG. 6 by the curve C6.

The AES system 20 for its part calculates a negative torque (that is to say taking the vehicle to the right) that makes it possible to bring the motor vehicle 10 to the avoidance trajectory T0. This torque is illustrated in FIG. 7 by the curve C4. The curve T4 illustrated in FIG. 6 shows the trajectory that would be followed by the motor vehicle 10 if it were controlled without interrupting the operation of the AES system 20.

It is then understood that, without the invention, the steering wheel torque and the torque generated by the AES system will be opposite. Since this situation is not dangerous, it does not impose countering the will of the driver.

Then, by virtue of the invention, the gain K1 is chosen equal to zero, so that the corrected gain K1ᵣₜ will transition continually from one to zero. The intermediate torque setpoint Ci will then increase gradually until it is canceled (see the curve C5 in FIG. 7), which will allow the vehicle to go on another traffic lane (see the trajectory T3 illustrated in FIG. 6), as the driver wishes.

The third particular case, illustrated in FIGS. 8 and 9, corresponds to a situation in which the driver would want to perform a greater avoidance than that planned by the AES system 20, then would want to return rapidly to his or her initial traffic lane.

At the start of the avoidance, the driver turns the steering wheel strongly to the left then, when the vehicle enters into the fourth zone Z4, he or she on the contrary exerts a negative torque on the steering wheel. This steering wheel torque is illustrated in FIG. 9 by the curve C9.

From the start of the avoidance, to bring the motor vehicle 10 to the avoidance trajectory T0, the AES system 20 then calculates a negative torque (that is to say taking the vehicle to the right). This torque is illustrated in FIG. 9 by the curve C7. The curve T6 illustrated in FIG. 8 shows the trajectory which would be followed by the motor vehicle 10 if it were controlled without interrupting the operation of the AES system 20.

As long as the vehicle is in the zone Z4 and it is deemed undesirable to interrupt the operation of the AES system 20, the gain K1 is kept equal to one.

On the other hand, when the vehicle enters into the second zone Z2, and the driver maintains his or her will to return rapidly to the initial traffic lane, there will come a moment where the steering wheel torque Cc and the torque generated by the AES system are of opposite signs. Since this situation is considered not to be dangerous, it does not impose countering the will of the driver.

Then, by virtue of the invention, the gain K1 is chosen equal to zero, so that the corrected gain K1ᵣₜ will transition continually from one to zero. The intermediate torque setpoint Ci imposed by the actuator 15 will then decrease gradually until it is canceled (see the curve C8 in FIG. 9), which will allow the vehicle to return rapidly to its initial traffic lane (see the trajectory T5 illustrated in FIG. 8), as the driver wishes.

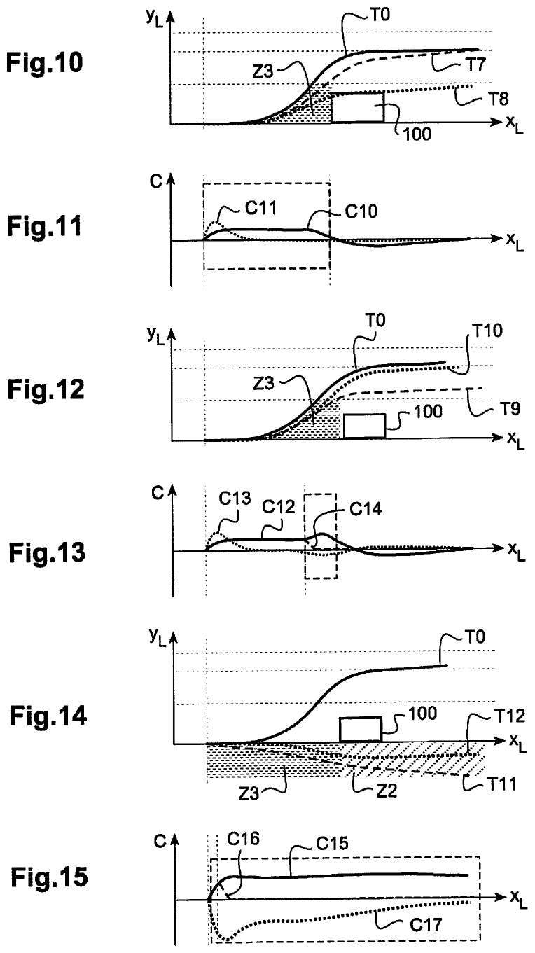

The fourth particular case, illustrated in FIGS. 10 and 11, corresponds to a situation in which the driver wants to perform an avoidance of the obstacle 100 on the left but in which the torque that he or she exerts on the steering wheel is not sufficient to effectively avoid the obstacle 100.

In this situation, the driver therefore exerts a steering wheel torque Cc that is positive and sufficiently high only when he or she detects the obstacle, then he or she relaxes this force too rapidly. This steering wheel torque is illustrated in FIG. 11 by the curve C11. The curve T8 illustrated in FIG. 10 shows the trajectory which would be followed by the motor vehicle 10 if it were controlled by only the driver.

In this situation, as long as the motor vehicle 10 is upstream of the obstacle 100, in the zone Z3, the AES system 20 calculates a positive torque (that is to say taking the vehicle to the left) that makes it possible to bring the motor vehicle 10 to the avoidance trajectory T0. This torque is illustrated in FIG. 11 by the curve C10.

This situation is therefore potentially dangerous, so that it imposes countering the will of the driver and not interrupting the operation of the AES system 20.

Then, by virtue of the invention, the gain K1 is kept equal to one, so that the steering wheel torque Cc has a reduced influence on the trajectory taken by the vehicle.

The curve T7 illustrated in FIG. 10 shows the trajectory which will then be followed by the motor vehicle 10.

The fifth particular case, illustrated in FIGS. 12 and 13, corresponds to a situation in which the driver performs a satisfactory avoidance of the obstacle 100 but does not then want to be diverted too far from the initial lane that he or she was taking to pass the obstacle 100 at a reduced distance.

In this situation, the driver initially turns the steering wheel to the left by exerting a steering wheel torque Cc which is positive, then he or she brings the steering wheel to the right by exerting a negative torque before even the motor vehicle 10 is level with the obstacle 100. This steering wheel torque is illustrated in FIG. 13 by the curve C13.

In this situation, the AES system 20 calculates a torque which is positive (that is to say taking the vehicle to the left) as long as the vehicle is upstream of the obstacle 100. This torque is illustrated in FIG. 13 by the curve C12.

The curve T10 illustrated in FIG. 12 shows the trajectory which would be followed by the motor vehicle 10 if it were controlled without interrupting the operation of the AES system 20.

It is then understood that, without the invention, that is to say without the possibility of interrupting the operation of the AES system 20, the steering wheel torque and the torque generated by the AES system will initially be of the same signs and then will be opposite, which will create a bad feeling for the driver.

Since the situation considered here is not dangerous, it does not impose countering the will of the driver.

Then, by virtue of the invention, the gain K1 is initially kept equal to one, then it will be brought to zero at the moment when the steering wheel torque Cc becomes negative and lower than the threshold Cc₃ₘᵢₙ (−2 Nm). Consequently, the corrected gain K1ᵣₜ will transition continually from one to zero. The intermediate torque setpoint Ci will then decrease gradually until it is canceled (see the curve C14 in FIG. 13), which will allow the vehicle to pass the obstacle 100 at a reduced distance (see the trajectory T9 illustrated in FIG. 12), as the driver wishes.

The sixth particular case, illustrated in FIGS. 14 and 15, corresponds to a situation in which the driver wants to avoid the obstacle 100 to the right whereas the avoidance trajectory T0 passes the obstacle 100 on the left.

In this situation, the driver, for his or her part, turns the steering wheel to the right by exerting a steering wheel torque Cc which is always negative and high. This steering wheel torque is illustrated in FIG. 15 by the curve C17.

In this situation, the AES system 20 calculates a torque which is positive (that is to say taking the vehicle to the left). This torque is illustrated in FIG. 15 by the curve C15.

The curve T12 illustrated in FIG. 14 shows the trajectory which would be followed by the motor vehicle 10 if it were controlled without interrupting the operation of the AES system 20. It can be seen that the torque imposed by the driver is sufficiently high to counter that imposed by the AES system. Nevertheless, the feeling remains very disagreeable for the driver.

In this situation, it is therefore desirable to be able to allow the driver the choice of the side by which he or she wants to avoid the obstacle 100.

Then, by virtue of the invention, the gain K1 is set equal to zero, so that the corrected gain K1ᵣₜ will transition continually from one to zero. The final torque setpoint Cr imposed by the actuator 15 will then decrease gradually until it is canceled (see the curve C16 in FIG. 15), which will allow the vehicle to avoid the obstacle on the right (see the trajectory T11 illustrated in FIG. 14), as the driver wishes.

In FIGS. 16 to 18, an example is represented of the trend over time of parameters, clearly illustrating the invention.

In FIG. 17, it can be seen that, by virtue of the signal S1, the AES system is activated at an instant to which corresponds to the moment of detection of an obstacle 100 on the initial trajectory of the motor vehicle 10, in proximity thereto. Also to be seen, by virtue of the signal S2, is that there is a wish to suspend the operation of the AES system between instants t2 and t4.

FIG. 16 shows the trend:
of the preliminary steering angle setpoint δ_{c},
of the saturated steering angle setpoint δₛ, and
of the measured steering angle δ.

It can be seen that, at the instant to of detection of the obstacle, it would be necessary for the steering angle to be directly higher than that actually measured.

By virtue of the controller which saturates the preliminary steering angle setpoint δ_{c}, the rate of variation of the saturated steering angle setpoint δₛ remains, between the instants t₀ and t₁, restricted so as not to generate instability.

Between the instants t₁ and t₂, it will no longer be necessary to saturate, in terms of amplitude or of rate of variation, the preliminary steering angle setpoint δ_{c}, so that the saturated steering angle setpoint δₛ will be equal to the latter.

At the instant t₂, as FIG. 18 shows, the gain K1 is set to zero to interrupt the operation of the AES system 20.

The corrected gain K1ᵣₜ then decreases linearly to reach, at an instant t₃, the value zero.

While the preliminary steering angle setpoint δ_{c} continues to increase, the saturated steering angle setpoint δₛ will then be kept constant between the instants t2 and t3, by virtue of the reset signals SA, SB.

At the instant t₃ and until the instant t4, the saturated steering angle setpoint δₛ will then be kept equal to the measured steering angle δ. In this way, the intermediate torque setpoint Ci is kept equal to zero, which leaves the driver solely in control of the maneuver.

At the instant t₄, as FIG. 18 shows, the gain K1 is set to one to suspend the interruption of the operation of the AES system 20.

The corrected gain K1ᵣₜ then increases linearly to also reach the value one.

At that instant t₄, by virtue of the reset signals SA, SB, the preliminary steering angle setpoint δ_{c} will then be brought equal to the measured steering angle δ. It then increases very rapidly.

By virtue of the controller which saturates the preliminary steering angle setpoint δ_{c}, the rate of variation of the saturated steering angle setpoint δₛ remains, in this situation, restricted so as not to generate instability.

It can be seen in FIG. 16 that the measured steering angle 8 does not correctly follow the saturated steering angle setpoint δₛ, because of the torque still imposed by the driver on the steering wheel 16. In fact, the trajectory followed is the resultant of the driver torque and of the AES request. If the driver manifests himself or herself actively on the steering wheel, he or she then takes back control.

The present invention is in no way limited to the embodiments described and represented, but the person skilled in the art will be able to add to it any variant according to the invention.

Thus, the method will be able to be applied to other types of areas in which a particular trajectory must be followed, for example in aeronautics or in robotics.

1. A method for autonomously controlling an actuator of a control system of an automotive device, the method comprising:
determining a reference trajectory;
determining a position of the automotive device with respect to a position of the reference trajectory;
acquiring a parameter relating to a force exerted by a driver on a manual control device of the control system;
calculating, by a computer, a controlling setpoint of the actuator;
the controlling setpoint being is calculated as a function of the parameter and of the position of the automotive device with respect to the position of the reference trajectory.

2. The control method as claimed claim 1, wherein
the automotive device is a motor vehicle which is suitable for traveling on roads and which comprises at least one drive wheel, wherein the manual control device is a steering wheel,
the control system allows each drive wheel to be steered, and
the parameter relates to a torque exerted by the driver of the motor vehicle on the steering wheel.

3. The control method as claimed in claim 1, wherein
the reference trajectory is determined so that the automotive device avoids an obstacle, and wherein, taking into consideration at least two zones of an environment of the automotive device whose limits depend on at least one of a position of the obstacle and the position of the reference trajectory with respect to the obstacle, the calculating of the controlling setpoint is performed by:
determining the zone in which the automotive device is located,
using an algorithm for calculating the controlling setpoint which is selected as a function of the zone in which the automotive device is located.

4. The control method as claimed in claim 3, wherein
provision is made to determine an indicator whose value depends on the zone in which the automotive device is located and on the parameter, wherein provision is made to generate a preliminary controlling setpoint of the actuator that makes it possible to bring the automotive device to the reference trajectory, and wherein provision is made to correct the preliminary setpoint as a function of the value of the indicator.

5. The control method as claimed in claim 4, wherein
the indicator is adapted to take only one or other of two values, wherein provision is made to determine, as a function of the indicator, a corrected indicator which varies continually between two values, and wherein the preliminary setpoint is corrected by multiplying its value by that of the corrected indicator.

6. The control method as claimed in claim 5, wherein
the automotive device being a motor vehicle which is suitable for traveling on a road, when the corrected indicator varies, the rate of variation of the corrected indicator is determined as a function of a speed of the motor vehicle and of a radius of curvature of the road, such that the lateral acceleration of the motor vehicle does not exceed a determined threshold.

7. The control method as claimed in claim 4, wherein
the preliminary setpoint is deduced from a steering angle setpoint of the wheels which is itself calculated as a function of the position of the automotive device with respect to the reference trajectory and which is filtered using a controller which satisfies a setpoint amplitude limiting model and a setpoint variation limiting model.

8. The control method as claimed in claim 3, wherein
the computer considers four zones associated with four different computation algorithms, including:
a zone situated upstream of the obstacle, between the reference trajectory and a protection line beyond which any collision with the obstacle is avoided,
a zone situated level with and downstream of the obstacle, between the reference trajectory and the protection line,
a zone situated upstream of the obstacle, on the side of the reference trajectory which is opposite the protection line, and
a zone of which a part is situated upstream of the obstacle, on the side of the protection line which is opposite the reference trajectory, and of which another part is situated level with and downstream of the obstacle, on the side of the reference trajectory which is opposite the protection line.

9. The control method as claimed in claim 3, wherein
when the automotive device moves from a first zone to a second zone, the computer continues to use the algorithm associated with the first zone as long as the automotive device has not gone beyond a hysteresis trajectory determined as a function of the reference trajectory.

10. An automotive device comprising:
at least one actuator which is adapted to influence a trajectory of the automotive device; and
a computer programmed to control the at least one actuator, the computer being programmed to implement the method of claim 1.
